(19) United States
(12) Patent Application Publication
(10) Pub. No.: US 2016/0141126 A1
(43) Pub. Date: May 19, 2016

(54) Electrical Contact for Vacuum Interrupter and Process for Producing Same

(71) Applicant: Hitachi, Ltd., Tokyo (JP)

(72) Inventors: Shigeru KIKUCHI, Tokyo (JP); Kunihiko TOMIYASU, Tokyo (JP); Kenji TSUCHIYA, Tokyo (JP); Takashi SATO, Tokyo (JP); Ayumu MORITA, Tokyo (JP)

(21) Appl. No.: 14/900,240

(22) PCT Filed: Sep. 5, 2014
(86) PCT No.: PCT/JP2014/073429

§ 371 Date: Dec. 21, 2015

(30) Foreign Application Priority Data
Oct. 23, 2013 (JP) 2013-219736

(51) Int. Cl. H01H 33/664; C22C 27/04; C22C 30/02; B22F 3/26; B22F 1/00; B22F 5/12; B22F 3/02; H01H 33/666; C22C 9/00

(52) U.S. Cl. CPC H01H 33/6643; H01H 33/666; C22C 27/04; C22C 30/02; C22C 9/00; B22F 1/0003; B22F 5/12; B22F 3/02; B22F 3/26; H01H 2201/03; H01H 2205/002; B22F 2201/10; B22F 2201/20; B22F 2301/10; B22F 2301/20; B22F 2998/10

(57) ABSTRACT

In an electrical contact in which aggregation phases including Cu are dispersed in a matrix phase including Mo, Cr, and Cu, a maximum grain size of the aggregation phases falls in a range of 4 to 20 μm and, when the total Cu content in the electrical contact is denoted by Wₜ, the Cu content in the matrix phase is expressed by C×Wₜ, where C ranges from 0.54 to 0.81. A process for producing an electrical contact including Mo, Cr, and Cu includes a step of compacting mixed Mo and Cr powders, thus forming a powder-compression compact and a step of making the powder-compression compact infiltrated with molten Cu.

### TECHNICAL FIELD

The present invention relates to an electrical contact for vacuum interrupters and a process for producing the electrical contact.

### BACKGROUND ART

A Cu—Cr base contact material has heretofore widely been used in an electrical contact of electric power switches such as vacuum circuit breakers and vacuum switch gears. This material has a structure in which chromium (Cr) grains which are arc-resistant components are dispersed in a copper (Cu) matrix phase having superior current-carrying performance. Chromium (Cr) emits electrons adequately and has a high melting point and arc resistance, thus giving voltage resistance performance. Therefore, increasing the amount of Cr improves high voltage resistance performance, but the amount of Cu decreases relatively and current-carrying/breaking performance lowers. For Cu—Cr base electrical contacts, hence, the current-carrying/breaking performance and the voltage resistance performance are contradictory with each other and it is difficult to make them compatible with each other.

As an electrical contact to cope with this problem, a Mo—Cr—Cu base material is proposed in, e.g., Patent Literature (PTL) 1. This contact material has a structure in which Cu is evenly dispersed in a matrix phase of Mo—Cr micro alloy which is used as arc-resistant components and is described to improve arc resistance and be able to suppress an increase in the resistance of the contact.

### CITATION LIST

### Patent Literature

PTL 1: Japanese Patent Application Laid-Open Publication No. 2012-7203

### SUMMARY OF INVENTION

### Technical Problem

In the Mo—Cr—Cu base contact proposed in the above-mentioned PTL 1, grains of highly conductive Cu aggregate into large ones, 20 to 150 μm in size, and these large grains of Cu exist in patches. This results in shortage of current-carrying paths in a matrix phase and decreases the conductivity of the contact material as a whole, which in turn poses a problem in which current-carrying performance and current-breaking performance become insufficient

An object of the present invention is to improve current-carrying/breaking performance and voltage resistance performance.

### Solution to Problem

The above object is achieved by the invention described in claims.

### Advantageous Effects of Invention

According to the present invention, it is possible to improve current-carrying/breaking performance and voltage resistance performance.

### BRIEF DESCRIPTION OF DRAWINGS

FIG. 1 is a cross-sectional view showing a structure of an electrode of a first embodiment.

FIG. 2 is a schematic diagram showing a cross-sectional view of structure morphology of an electrical contact of the first embodiment.

FIG. 3 is a diagram showing a structure of a vacuum interrupter of a second embodiment.

FIG. 4 is a diagram showing a structure of a vacuum circuit breaker of a third embodiment.

### DESCRPTION OF EMBODIMENTS

In producing an electrical contact including Mo—Cr—Cu matrix phases and Cu-aggregation phases, the present inventors considered improving current-carrying performance and current-breaking performance by micrifying Cu-aggregation phases dispersed in an Mo—Cr—Cu matrix phase and increasing the amount of Cu contained in the matrix phases, thus increasing the conductivity of the entire electrical contact.

First, the present inventors thought that the grain size of Cu-aggregation phases and the Cu content in an Mo—Cr—Cu matrix phase depend on molten infiltration paths of Cu of an Mo—Cr powder-compression compact, that is, its porosity, and measured the porosity of the Mo—Cr powder-compression compact after being heated. We compacted mixed powders with a composition of 77 wt % Mo to 23 wt % at pressure of 294 MPa and produced a powder-compression compact. After leaving this powder-compression compact in vacuum at temperature ranging from 400 to 1100° C. for one hour, we measured its porosity. The porosity of the body after being heated at 400° C. was 42%, whereas the porosity of the body after being heated at 1100° C. was 35%. At higher heating temperature, the porosity decreased. This is because, at higher heating temperature, diffusion between Mo and Cr becomes significant and narrows the paths (pores that molten Cu enters. Observation of a cross-section structure of the powder-compression compact after being heated revealed that pores (Kirkendall voids) which are several 10 μm in size resulting from diffusion exist in patches.

In this way, when a powder-compression compact is infiltrated with Cu after being sintered, it becomes hard to make a matrix phase to be infiltrated with Cu (it becomes hard to trap Cu in a matrix phase) and, moreover, Cu with which a matrix phase has not been infiltrated enters a large pore and forms a large aggregation phase.

Based on this knowledge, in an embodiment disclosed herein, an Mo—Cr—Cu matrix phase including Cu is formed by making an Mo—Cr powder-compression compact infiltrated with molten Cu after ensuring plenty of Cu infiltration paths in the Mo—Cr powder-compression compact and the grain size of Cu-aggregation phases dispersed in a matrix phase was controlled to be smaller than ever before.

An electrical contact of the present embodiment can be obtained by a process described below. First, Cr and Mo powders are mixed and the mixed powders are compacted to produce a powder-compression compact. Then, the powder-compression compact is infiltrated with molten Cu. In this infiltration process, atmosphere should preferably be inert gas (such as Ar) atmosphere or depressurized environment (high vacuum) below atmospheric pressure, because Cu is hard to oxidize in such atmosphere. The powder-compression compact is sintered by heat of the molten Cu with which the powder-compression compact is infiltrated, Cu infiltration and sintering that go on simultaneously bring about suppression of diffusion between Mo and Cr, ensuring plenty of Cu infiltration paths, and making a larger amount of Cu than ever before contained in a Mo—Cr—Cu matrix phase. Besides, the size of pores resulting from Mo—Cr diffusion can be reduced and the size of Cu-aggregation phases which are formed by Cu entering the pores can be controlled to be 4 to 20 μm.

An electrical contact of the present embodiment has a structure in which Cu-aggregation phases whose grain size is 4 to 20 μm are dispersed in a matrix phase including Mo—Cr—Cu. When the total Cu content in the electrical contact is denoted by Wₜ, the Cu content (Wₘ) in a matrix phase is expressed by C×Wₜ, where C ranges from 0.54 to 0.81. A matrix phase is comprised of ternary system of Mo—Cr—Cu and a large amount of Cu which is a good electrical conductor is contained in a matrix phase as well; this brings a marked improvement in the conductivity of the electrical contact. Nevertheless, a matrix phase also includes traces of inevitable elements other than the three components of Mo—Cr—Cu. Moreover, the grain size of Cu-aggregation phases existing in patches can be reduced to a relatively small size. This enables dispersion of the Cu-aggregation phases more evenly in the electrical contact and contributes to an improvement in the conductivity. Since the Cu content in a matrix phase is proportional to the total Cu content in the electrical contact, it would become easy to design a material composition to obtain desired electrical characteristics and, besides, three-dimensional coupling of Cu in the matrix phase forms conduction paths including Cu-aggregation phases. Improvement in the conductivity as described above leads to improvement in current-carrying performance and current-breaking performance.

Composition of the entire electrical contact is as follows: Mo is 40 to 60 wt %, Cr is 10 to 20 wt %, and the remainder is Cu and inevitable impurities. Having this composition including large amounts of Mo and Cr, the electrical contact can develop sufficiently high voltage resistance. An Mo—Cr—Cu matrix phase in which Cu minutely penetrates a skeletal structure formed with adequately dispersed Mo—Cr is formed and the size of Cu-aggregation phases can be reduced. Thus, superior conductivity as described above can be provided and current-carrying performance and current-breaking performance can be improved without need to add Cu excessively.

The Mo—Cr—Cu matrix phase has a crystal grain size of less than 4 μm and includes Cu as much as the above Cu content (Wₘ). This produces three-dimensional coupling of Cu in the matrix phase, so that the electrical contact develops high conductivity. Besides, by reducing the percentage of the Cu contents in the Cu-aggregation phases in the entire electrical contact to 20 wt % or less, the total amount of Mo and Cr can be increased to 80 wt %; thus high voltage resistance can be obtained.

An electrical contact of the present embodiment has a disc shape and the outer periphery of its one side surface is bonded onto a current-carrying member. When separating two electrical contacts facing each other, each having the above shape, to break current, an arc produced between the contacts can be trapped by generating a vertical magnetic field between the contacts and extinguishing the arc in the magnetic field. By means of this, an electrode having superior current-breaking performance can be obtained.

A disc-shape electrical contact has a shape in which it has a center hole formed in the disc center and a plurality of perforated slit grooves formed from the disc center toward the outer periphery, but not communicating with the center hole. With this windmill-like shape, it is possible to drive out an arc produced between the electrical contacts toward the outer periphery of the contacts by electromagnetic force and break current quickly and the contacts develop superior current-breaking performance.

A vacuum interrupter of an embodiment disclosed herein is equipped with a pair of a stationary electrode and a movable electrode in a vacuum case. At least one of the stationary and movable electrodes is configured as an electrode of the present embodiment. An electric power switch such as a vacuum circuit breaker and a vacuum switch gear is equipped with an electrical opening/closing means in which a plurality of vacuum interrupters of the present embodiment are connected in series by conductors and a movable electrode is driven. By means of this, it is possible to realize a vacuum load-break switch with a relatively large capacity, satisfying both of high voltage resistance and large current breaking.

In the following, embodiments will be described in detail, but the present invention is not limited to these embodiments.

### Embodiment 1

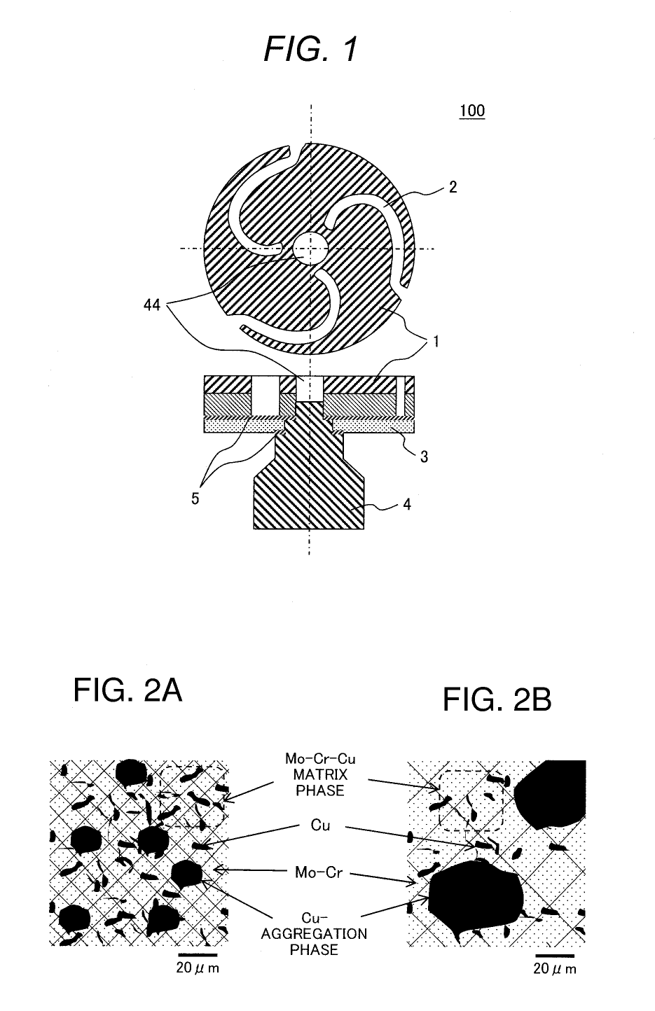

Electrical contacts having a composition which is specified in Table 1 were produced and an electrode 100 was produced using these contacts. In Table 1, contact composition is specified with the exclusion of purities for convenience. FIG. 1 is a cross-sectional view showing a structure of an electrode 100 produced. In FIG. 1, reference numeral 1 denotes an electrical contact; 2 denotes a curved slot for giving a driving force to an arc; 3 denotes a reinforcing plate made of stainless steel; 4 denotes an electrode rod; 5 denotes brazing filler metal; and 44 denotes a center hole for preventing an arc produced in the center of the electrical contact 1 from staying there.

A process of producing an electrical contact 1 of an example specified in Table 1 is as follows. First, an Mo powder (an average grain size of 3 μm) and a Cr powder (gain size is less than 60 μm) in predetermined quantities were mixed, these mixed powders were put in a mold with a diameter of 70 mm, and the mixed powders were compacted at a pressure of 157 to 294 MPa, and a powder-compression compact was obtained. In this process, a mix ratio of Mo and Cr powders and the compaction pressure were adjusted so that contact composition values after molten Cu infiltration will be obtained approximately as specified in Table 1. If the compaction pressure is less than 157 MPa, a compacted body loosens when infiltrated with Cu and its structure and composition become inhomogeneous; therefore, the compaction pressure should preferably be equal to or more than 157 MPa. Then, a predetermined quantity of an oxygen-free cupper ingot was put on the powder-compression compact, it was heated at 1160° C. for 2 hours in vacuum on the order of 10⁻² Pa, the powder-compression compact was infiltrated with molten Cu, and the material of the electrical contact 1 was produced.

An arbitrary cross section of the material of the electrical contact 1 obtained was observed with an optical microscope and an area ratio of an Mo—Cr—Cu matrix phase and Cu-aggregation phases was measured using an image processing device. A maximum grain size of Cu-aggregation phases is a value representing the greatest one of the maximum diameters of all grains in an image. Thus obtained area ratios of each phase are converted to the weight percentages of the components which are also presented in Table 1. As examples of structure morphology, a cross-section structure of embodiment example No. 3 is shown in FIG. 2(a) and a cross-section structure of comparative example No. 8 is shown in FIG. 2(b) in schematic diagrams. Conductivity also specified in Table 1 is conductivity measurements taken in an arbitrary cross section with an eddy current conductivity meter and is represented as values (IACS) relative to the conductivity of annealed pure crupper assumed as 100%.

The ranges of the compositions of embodiment examples No. 1 to No. 7 are as follows: Mo is 40 to 60 wt %, Cr is 10 to 20 wt %, and Cu occupies the remainder. Assuming that the total Cu content in the electrical contact is denoted by Wₜ, when the Cu content (Wₘ) in an Mo—Cr—Cu matrix phase is expressed C×Wt, C falls in a range of 0.54 to 0.81. Moreover, the maximum grain size of Cu-aggregation phases is 4 to 20 μm and the percentage of these phases in the entire contact is less than 20 wt %.

In contrast to these examples, comparative example No. 8 was obtained by heating the powder-compression compact at 1100° C. before Cu infiltration. Since Mo—Cr diffusion in the powder-compression compact progresses to narrow Cu infiltration paths, the Cu content in the Mo—Cr—Cu matrix phase decreases and the value of C in the equation Wₘ=C×Wₜ decreases. On the other hand, since the entire contact composition of the example No. 8 falls within the range of embodiment examples, surplus Cu that failed to enter the matrix phase forms Cu-aggregation phases as shown in FIG. 2(b) and both the size (grain size) and amount of these phases have values out of the range of embodiment examples.

For comparative examples No. 9 and No. 10, their entire contact compositions are out of the range of embodiment examples. Example No. 9 has a smaller amount of Cr and most of Cr dissolves in Mo when the powder-compression compact is heated, which narrows Cu infiltration paths, with the result that the value of C in the equation Wₘ=C×Wₜ decreases. On the other hand, an absolute amount of Cu is larger in the example No 9; this makes a structure in which large Cu-aggregation phases exist unevenly in patches. Example No. 10 has a smaller amount of Cu in total; this makes a structure only with a Mo—Cr—Cu matrix phase without the formation of Cu-aggregation phases.

The obtained material was machined and an electrical contact 1 with a diameter of 65 mm, which is shown in FIG. 1, was produced. A process of producing an electrode 100 is as follows. An electrode rod 4 made of oxygen-free copper and a reinforcing plate made of SUS304 were produced in advance by machining. The electrical contact 1 obtained as described previously, the reinforcing plate 3, and the electrode rod 4 with the intermediate positioning of brazing filler metal 5 between the electrical contact and each of the plate and rod were assembled and this assembly was heated at 970° C. for 10 minutes in vacuum at 8.2×10⁻⁴ Pa or below. The electrode 100 was thus produced which is shown in FIG. 1. If the electrical contact 1 has sufficient strength, the reinforcing plate 3 may be omitted.

### Embodiment 2

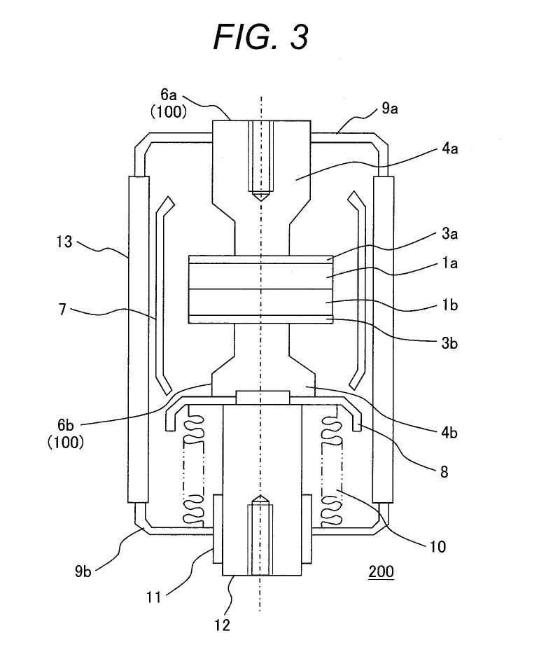

A vacuum interrupter 200 was produced by using the electrode 100 produced in Embodiment 1. FIG. 3 is a diagram showing the structure of the vacuum interrupter of the present embodiment. Rated specifications of this vacuum interrupter 200 are as follows: voltage is 24 kV, current is 1250 A, and breaking current is 25 kA. In FIG. 3, reference numeral 1a denotes a stationary electrical contact; 1b denotes a movable electrical contact; 3a and 3b denote reinforcing plates; 4a denotes a stationary electrode rod; and 4b denotes a movable electrode rod. Using these members, a stationary electrode 6a (100) and a movable electrode 6b (100) are configured. In the present embodiment, the stationary and movable electrical contacts are placed so that their curved grooves will be aligned on the contact surface.

The movable electrode 6b is brazed onto a movable electrode holder 12 with the intermediate positioning of a movable-side shield 8 which prevents scattering of metal vapor or the like at current breaking. These members are held in high vacuum in a brazed and sealed case formed of a stationary-side end plate 9a, a movable-side end plate 9b, and an insulated barrel 13. This vacuum interrupter is connected to external conductors at threaded portion on the stationary electrode 6a and the movable electrode holder 12. At the inner side of the insulated barrel 13, a shield 7 is provided to prevent scattering of metal vapor or the like at current breaking. Also, a guide 11 for supporting a sliding portion is provided between the movable-side end plate 9b and the movable electrode holder 12. Bellows 10 are provided between the movable-side shield 8 and the movable-side end plate 9b to enable the movable electrode holder 12 to go up and down, making the stationary electrode 6a and the movable electrode 6b open and close, while keeping vacuum inside the vacuum interrupter.

### Embodiment 3

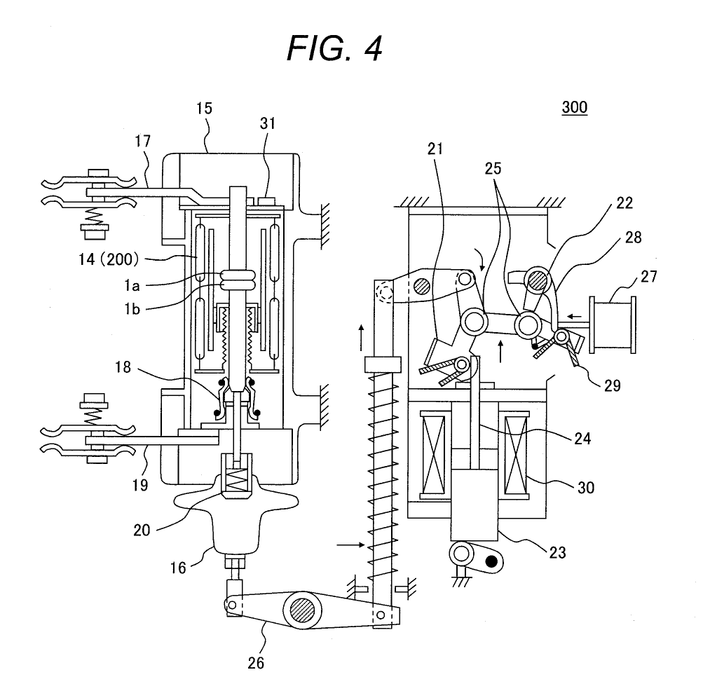

A vacuum circuit breaker 300 equipped with the vacuum interrupter 200 produced in Embodiment 2 was produced. FIG. 4 is a structure diagram of the vacuum circuit breaker 300, showing the vacuum interrupter 14 (200) in the present embodiment and its operating mechanism.

The vacuum circuit breaker 300 has a structure in which the operating mechanism is located in its front side and three epoxy barrels 15 which are of a three phase integration type and support the vacuum interrupter 14 (200) are located in its back side. The vacuum interrupter (200) is opened and closed by the operating mechanism via an insulated operating rod 16.

When the vacuum circuit breaker 300 is placed in a closed state, current flows through an upper terminal 17, the electrical contact 1, current collector 18, and a lower terminal 19. Contact force between the electrodes is maintained by a contact spring 20 attached to the insulated operating rod 16. The contact force between the electrodes and electromagnetic force due to a short-circuit current are held by a holding lever 21 and a prop 22. When a closing coil 30 is excited, a plunger 23 pushes a roller 25 up via a knocking rod 24 from an open state, thereby turning a main lever 26 to close the electrodes. After that, the closed state is held by the holding lever 21.

When the vacuum circuit breaker 300 is placed in a trippable state, a tripping coil 27 is excited, and a tripping lever 28 disengages the prop 22, thereby turning the main lever 26 to open the electrodes.

When the vacuum circuit breaker 300 is placed in an open state, after the electrodes have been opened, the link recovers by the action of a reset spring 29 and, at the same time, the prop 22 engages in this state, exciting the closing coil 30 puts the circuit breaker into the closed state. Reference numeral 31 denotes an exhaust stack.

### Embodiment 4

A performance test was conducted in which the electrical contacts 1 produced in Embodiment 1 were employed in the vacuum interrupter 200 described in Embodiment 2, installed in the vacuum circuit breaker 300 described in Embodiment 3. For each electrical contact, a maximum breaking current value and judgment of whether the contact can keep voltage resistance performance after breaking are also specified in Table 1. Rated specifications of this vacuum interrupter 200 are as follows: voltage is 24 kV, current is 1250 A, and breaking current is 25 kA. A maximum breaking current value that is required in practical use is 35 kA. Voltage resistance performance is 50 kV in commercial frequency. Therefore, a contact whose maximum breaking current value is above 35 kA was judged as “good (O)” and a contact that can keep resistant to a voltage of 50 kV was judged as “good (O)”.

Electrical contacts of embodiment examples No. 1 to No. 7 each show values in a proper range in terms of composition, Cu content in an Mo—Cr—Cu matrix phase, grain size of Cu-aggregation phases, etc. and were capable of satisfactorily keeping a voltage resistance state along with good conductivity and a breaking current value above 35 kA.

An electrical contact of example No. 8 has sufficient conductivity of the entire contact and was capable of keeping voltage resistance performance after breaking. However, because of its inhomogeneous structure in which Cu-aggregation phases with a relatively large grain size exist in patches, Cu sublimation spots are generated unevenly by arc heating. Its current breaking behavior is unstable and its maximum breaking current value is below 35 kA. Its current breaking performance was regarded as insufficient.

For an electrical contact of example No. 9, the absolute amount of Cu included in it is large and it has high conductivity. Thus, it shows a relative high value as the maximum breaking current value, but its voltage resistance performance was regarded as insufficient because Mo—Cr amounts are small.

For an electrical contact of example No. 10, its conductivity is significantly low because the absolute amount of Cu is small and its current breaking performance is regarded as insufficient. Besides, the contact surface after current breaking becomes considerably rough and this induces discharge between the contacts. Therefore, its voltage resistance performance was not kept.

In this way, it was verified that the electrical contacts of embodiment examples satisfy both of high voltage resistance and large current breaking and can be applied to an electric power switch with a relatively large capacity.

TABLE 1

| | | Contact | | | | Mo—Cr—Cu | | |
|---|---|---|---|---|---|---|---|---|
| | | Composition | | | Heating | Matrix Phase | | |
| | | (wt %) | | | Temp. (° C.) | Cu content | Cu-aggregation Phases | |
| | | | | Cu | Before Molten | (wt %) | Max. grain | Percentage in Entire |
| Sort | No. | Mo | Cr | [Wₜ] | Cu Infiltration | [Wₘ] | size (μm) | Content (wt %) |
| Embodiment | 1 | 40 | 10 | 50 | — | 38.5 | 20 | 11.5 |
| Ex. | 2 | 40 | 20 | 40 | — | 32.4 | 18 | 7.6 |
| | 3 | 50 | 15 | 35 | — | 26.0 | 17 | 9.0 |
| | 4 | 60 | 10 | 30 | — | 16.2 | 11 | 13.8 |
| | 5 | 60 | 20 | 20 | — | 14.4 | 4 | 5.6 |
| | 6 | 50 | 15 | 35 | — | 28.0 | 15 | 7.0 |
| | 7 | 50 | 15 | 35 | — | 19.3 | 19 | 15.7 |
| Comparative. | 8 | 50 | 15 | 35 | 1100 | 13.7 | 55 | 21.3 |
| Ex. | 9 | 35 | 5 | 60 | 600 | 28.8 | 93 | 31.2 |
| | 10 | 65 | 25 | 10 | 600 | 10 | — | 0 |

| | | | Max. Breaking | | | |
|---|---|---|---|---|---|---|
| | | | Current | | | |
| | | | (kA) | | Keeping of Voltage | |
| | | | | Breaking | Resistance | |
| | | Conductivity | | Current | Performance After | Value of C in |
| Sort | No. | (IACS %) | | above 35 kA | Breaking | Wₘ = C × Wₜ |
| Embodiment | 1 | 34 | 37.7 | ∘ | ∘ | 0.77 |
| Ex. | 2 | 32 | 37.0 | ∘ | ∘ | 0.81 |
| | 3 | 27 | 36.5 | ∘ | ∘ | 0.74 |
| | 4 | 23 | 35.5 | ∘ | ∘ | 0.54 |
| | 5 | 22 | 35.2 | ∘ | ∘ | 0.72 |
| | 6 | 28 | 37.2 | ∘ | ∘ | 0.80 |
| | 7 | 25 | 35.2 | ∘ | ∘ | 0.55 |
| Comparative. | 8 | 23 | 34.2 | x | ∘ | 0.39 |
| Ex. | 9 | 37 | 36.5 | ∘ | x | 0.48 |
| | 10 | 15 | 26.6 | x | x | 10 |

### REFERENCE SIGNS LIST

1: Electrical contact,

1a: Stationary electrical contact,

1b: Movable electrical contact,

2: Curved slit groove,

3, 3a, 3b: Reinforcing plate,

4, 4a, 4b: Electrode rod,

5: Brazing filler metal,

6a: Stationary electrode,

6b: Movable electrode,

7: Shield,

8: Movable-side shield,

9a: Stationary-side end plate,

9b: Movable-side end plate,

10: Bellows,

11: Guide,

12: Movable electrode holder,

13: insulated barrel,

14: Vacuum interrupter,

15: Epoxy barrel,

16: Insulated operating rod,

17: Upper terminal,

18: Current collector,

19: Lower terminal,

20: Contact spring,

21: Holding lever,

22: Prop,

23: Plunger,

24: Knocking rod,

25: Roller,

26: Main lever,

27: Tripping coil,

28: Tripping lever,

29: Reset spring,

30: Closing coil,

31: Exhaust stack,

44: Center hole,

100: Electrode,

200: Vacuum interrupter,

300: Vacuum circuit breaker.

1. An electrical contact in which aggregation phases including Cu are dispersed in a matrix phase including Mo, Cr, and Cu, wherein:
a maximum grain size of the aggregation phases falls in a range of 4 to 20 μm, and
when the total Cu content in the electrical contact is denoted by Wₜ, the Cu content in the matrix phase is expressed by C×Wₜ, where C ranges from 0.54 to 0.81.

2. The electrical contact according to claim 1, wherein composition of the entire electrical contact comprises Mo of 40 to 60 wt %, Cr of 10 to 20 wt %, and the remainder consisting of Cu and inevitable impurities.

3. The electrical contact according to claim 1, wherein the matrix phase has a crystal grain size of less than 4 μm.

4. The electrical contact according to claim 1, wherein the Cu contents in the aggregation phases are 20 wt % or less in the entire electrical contact.

5. An electrode comprising an electrical contact according to claim 1 having a disc shape and an electrode rod attached to one-side surface of the electrical contact.

6. A vacuum interrupter comprising a pair of a stationary electrode and a movable electrode in a vacuum case, wherein at least one of the stationary electrode and the movable electrode is an electrode as set forth in claim 5.

7. An electric power switch comprising an electrical opening/closing means in which a plurality of vacuum interrupters as set forth in claim 6 are connected in series by conductors and the movable electrode is driven.

8. A process for producing an electrical contact including Mo, Cr, and Cu, comprising:
a step of compacting mixed Mo and Cr powders, thus forming a powder-compression compact; and
a step of making the powder-compression compact infiltrated with molten Cu.

9. The process for producing an electrical contact according to claim 8, wherein the step of making the powder-compression compact infiltrated with molten Cu is performed in inert gas atmosphere or depressurized atmosphere.
